(19) United States
(12) Patent Application Publication
(10) Pub. No.: US 2002/0007314 A1
(43) Pub. Date: Jan. 17, 2002

(54) System, server, device, method and program for displaying three-dimensional advertisement

(75) Inventor: Yukio Maruyama, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/903,621

(22) Filed: Jul. 13, 2001

(30) Foreign Application Priority Data
Jul. 14, 2000 (JP) 214626/2000

(51) Int. Cl. G06F 17/60; G06T 15/00

(52) U.S. Cl. 705/14; 345/419

(57) ABSTRACT

An advertisement client displays a three-dimensional virtual space. Shown within this three-dimensional virtual space are an avatar, which is a graphical representation of a user in a virtual space, and a three-dimensional advertisement to be moving. The advertisement client stores data for showing the three-dimensional advertisement. An advertisement server connected to the advertisement client through a network includes a timer for measuring a predetermined period of time. Every time the predetermined period of time elapses, the advertisement server sends a signal, for instructing the advertisement client to show a three-dimensional advertisement, to the advertisement client. In response to the signal sent from the advertisement server, the advertisement client shows the three-dimensional advertisement in a predetermined position within the three-dimensional virtual space.

### BACKGROUND OF THE INVENTION

1. Field of the Invention

The present invention relates to a system, server, display device, method and program for showing an ad through a network.

2. Description of the Related Art

With the widespread of the Internet usage, users can use various services through the Internet with the operation of a computer, etc.

For example, the users can purchase items at a virtual shopping mall prepared in a three-dimensional virtual space on the Internet, with the operation of their computer. At this time, an ad may appear on a display of the computer of each user.

The ad includes a 2-D image without any movement. Hence, such an ad can not satisfactorily express a target item, and the users may not easily know or sense the physical quality, etc. of the item. If the ad is shown without any movement, the feature or characteristics of the item may not desirably be expressed. Therefore, a target item has conventionally been advertised through the Internet at a low effectiveness.

Any services other than the virtual shopping mall are disclosed, for example, in Unexamined Japanese Patent Application KOKAI Publications Nos. 2000-40088 and 2000-40161.

According to a technique disclosed in Unexamined Japanese Patent Application KOKAI Publication No. 2000-40088, an avatar which is a graphical representation of a user in a virtual space is to participate in a three-dimensional virtual space. In addition, movies or concerts are shown on a virtual screen which is set in the three-dimensional virtual space.

According to a technique disclosed in Unexamined Japanese Patent Application KOKAI Publication No. 2000-40161, likewise in the above publication, the avatar of the user is to participate in the three-dimensional virtual space. Further, those images sent from broadcasting stations are displayed on a virtual screen set in the three-dimensional virtual space.

In any of the above publications, a technique for showing ads at a high effectiveness has not been disclosed.

The entire disclosures of Unexamined Japanese Patent Application KOKAI Publications Nos. 2000-40088 and 2000-40161 are incorporated herein by reference.

### SUMMARY OF THE INVENTION

It is accordingly an object of the present invention to provided a system, server, display device, method, and program for providing ads at a high effectiveness.

In order to achieve the above object, according to the first aspect of the present invention, there is provided a three-dimensional advertisement system, comprising:

a server which sends an instruction to at least one client connected to the server through a network to show an advertisement; and

the at least one client which displays a three-dimensional virtual space, and shows a three-dimensional advertisement to be moving, in a predetermined position within the three-dimensional virtual space, in accordance with the instruction which is sent from the server through a network.

According to this invention, effective ads can be provided.

The at least one client may include:

a display which displays the three-dimensional virtual space showing an avatar which is a graphical representation of a user in a virtual space; and

a controller which determines a position where the advertisement is shown in the three-dimensional virtual space, in accordance with a position and/or direction of the avatar, and controls the display to show the advertisement in the determined position.

The at least one client may include:

a memory which stores data regarding the advertisement;

a display which displays the three-dimensional virtual space; and

a controller which controls the display to display the advertisement in a predetermined position within the three-dimensional space using the data stored in the memory.

The memory may store, as the data regarding the advertisement, model data of a target item to be advertised and outline data indicating a type of the item to be advertised and movement of an image of the item; and

the controller may control the display to show a three-dimensional advertisement to be moving, using the model data and outline data.

The memory further may store, as the data regarding the advertisement, voice data representing back music and/or catch phrase of the advertisement.

The memory may store a plurality of pieces of outline data which are identified by outline IDs, respectively;

the server may send a predetermined outline ID to the at least one client; and

the controller may control the display to display a predetermined advertisement, in accordance with one piece of the plurality of pieces of the outline data which is identified by the outline ID sent from the server.

The server may include:

a timer which measures a predetermined period of time; and

a transmission unit which sends a predetermined outline ID to the at least one client, every time the predetermined period of time measured by the timer elapses.

In order to achieve the above object, according to the second aspect of the present invention, there is provided a three-dimensional advertising server, comprising:

a timer which measures a predetermined period of time; and

a transmission unit which transmits a signal for instructing at least one client to show a three-dimensional advertisement to be moving to the at least one client, every time the predetermined period of time measured by the timer elapses, and the at least one client being connected to the three-dimensional advertising server through a network, displaying a three-dimensional virtual space, and showing the three-dimensional advertisement in a predetermined position within the three-dimensional virtual space.

In order to achieve the above object, according to the third aspect of the present invention, there is provided a three-dimensional advertisement display device, comprising:

a memory which stores data regarding a three-dimensional advertisement to be moving;

a display which displays a three-dimensional virtual space; and

a controller which controls the display to display a three-dimensional advertisement to be moving using the data stored in the memory, in a predetermined position within the three-dimensional virtual space, in response to an instruction sent from a server connected to the three-dimensional advertisement display device.

The display may display a three-dimensional virtual space showing an avatar which is a graphical representation of a user in a virtual space; and

the controller may determine a position where the ad is shown within the three-dimensional virtual space, in accordance with a position and/or direction of the avatar, and control the display to display the ad in the determined position.

The memory may store, as the data regarding the ad, model data of a target item to be advertised and outline data indicating a type of the item to be advertised and movement of an image of the ad; and

the controller may control the display to display a three-dimensional advertisement to be moving using the model data and outline data.

The memory may further store, as the data regarding the ad, voice data representing back music and/or a catchphrase of the ad.

In order to achieve the above object, according to the fourth aspect of the present invention, there is provided a method for displaying a three-dimensional advertisement, comprising:

sending an instruction from a server to at least one client, connected to the server through a network and displaying a three-dimensional virtual space, to show an ad; and

displaying, on the at least one client, a three-dimensional advertisement to be moving, in a predetermined position within the three-dimensional virtual space, in accordance with the instruction of the server.

The displaying the three-dimensional advertisement may include:

displaying, on the at least one client, a three-dimensional virtual space showing an avatar which is a graphical representation of a user in a virtual space;

determining, in the at least one client, a position where to show the three-dimensional advertisement in the three-dimensional virtual space, in accordance with a position and/or direction of the avatar; and

displaying, on the at least one client, the three-dimensional advertisement in the determined position.

The displaying the three-dimensional advertisement may include displaying, on the at least one client, the three-dimensional advertisement in a predetermined position within the three-dimensional virtual space, using data regarding the three-dimensional advertisement and being supplied in advance.

The sending an instruction may include:

measuring, in the server, a predetermined period of time; and

sending, from the server, a signal for instructing the at least one client to show the three-dimensional advertisement, every time the predetermined period of time elapses.

In order to achieve the above object, according to the fifth aspect of the present invention, there is provided a program for controlling a computer to function as a three-dimensional advertisement display device comprising:

a timer which measures a predetermined period of time; and

a transmission unit which transmits a signal for instructing at least one client to show a three-dimensional advertisement to be moving to the at least one client, every time the predetermined period of time measured by the timer elapses, and the at least one client being connected to the computer through a network, displaying a three-dimensional virtual space, and showing the three-dimensional advertisement in a predetermined position within the three-dimensional virtual space.

In order to achieve the above object, according to the sixth aspect of the present invention, there is provided a program for controlling a computer to function as a three-dimensional advertisement display device comprising:

a memory which stores data regarding a three-dimensional advertisement to be moving;

a displaying which displays a three-dimensional virtual space; and

a controller which controls the display to display a three-dimensional advertisement to be moving, in a predetermined position within the three-dimensional virtual space using the data stored in the memory, in response to an instruction sent from a server connected to the computer through a network.

### BRIEF DESCRIPTION OF THE DRAWINGS

These object and other objects and advantages of the present invention will become more apparent upon reading of the following detailed description and the accompanying drawings in which:

FIG. 1 is a block diagram showing the structure of a three-dimensional advertisement system according to an embodiment of the present invention;

FIG. 2 is a block diagram showing the structure of an advertisement server included in the three-dimensional advertisement system of FIG. 1;

FIG. 3 is a block diagram showing the structure of an advertisement client included in the three-dimensional advertisement system of FIG. 1;

FIG. 4A is a flowchart showing a client management process which is carried out by a coordinate management section included in the advertisement server of FIG. 2, and FIG. 4B is a flowchart showing an advertising process which is carried out by an action processor included in the advertisement server of FIG. 2;

FIG. 5 is a diagram showing a three-dimensional virtual space showing an avatar which moves under the control of another user;

FIG. 6A is a flowchart showing an avatar operational process which is carried out by a coordinate management section included in the advertisement client of FIG. 3, FIG. 6B is a flowchart showing a coordinate-data reception process which is carried out by the coordinate management section, and FIG. 6C is a flowchart showing an advertising process which is carried out by an action processor included in the advertisement client of FIG. 3;

FIGS. 7A and 7B are diagrams showing the states before and after a user's avatar moves within the three-dimensional virtual space;

FIGS. 8A and 8B are diagrams showing the states before and after the another user's avatar moves within the three-dimensional virtual space;

FIGS. 9A and 9B are diagrams for showing the state in which a three-dimensional advertisement moves within the three-dimensional virtual space;

FIG. 10 is a diagram showing an example of a three-dimensional advertisement shown in a predetermined position within the three-dimensional virtual space;

FIG. 11 is a diagram showing an example of a three-dimensional advertisement shown in a predetermined position within the three-dimensional virtual space; and

FIG. 12 is a block diagram showing the another structure of the advertisement client included in the three-dimensional advertisement system according to the embodiment of the present invention.

### DETAILED DESCRIPTION OF THE PREFERRED EMBODIMENT

A three-dimensional advertisement system according to an embodiment of the present invention will now be described with reference to the accompanying drawings.

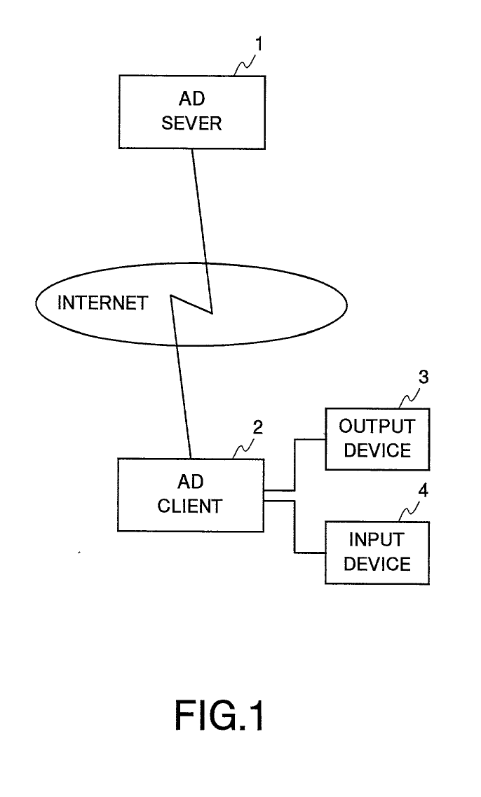

The three-dimensional advertisement system of the present invention provides users with three-dimensional (motion) ads to be moving, in a three-dimensional virtual space. The three-dimensional advertisement system comprises an advertisement server 1 and an advertisement client 2 which are connected with each other through the Internet, as shown in FIG. 1.

The advertisement server 1 operates in accordance with a program and data, which are provided in advance, and supplies a plurality of clients 2 connected with each other through the Internet with various three-dimensional advertisements. Note that, in FIG. 1, only one advertisement client 2 is exemplarily shown for the sake of simple illustration.

The advertisement client 2 operates in accordance with a program and data, which are provided in advance, and shows various three-dimensional advertisements which are supplied from the advertisement server 1 to users. Shown in the above-described three-dimensional virtual space includes not only three-dimensional advertisements, but also an avatar which is a graphical representation of a user in the virtual space. The user controls his/her avatar, so as to succeed in travelling/moving within the three-dimensional virtual space.

The advertisement client 2 is connected to an output device 3 and an input device 4. The output device 3 includes a display, etc., while the input device 4 includes a keyboard, a mouse, etc. The advertisement client 2 controls the output device 3 to display the three-dimensional virtual space for showing three-dimensional advertisements and the avatar, so as to provide the user with the three-dimensional advertisements. The advertisement client 2 moves the avatar within the three-dimensional virtual space, in accordance with a signal sent from the input device 4 with the operation of the user. Particularly, the advertisement client 2 changes a display range of the three-dimensional virtual space.

The structure of the advertisement server 1 will now specifically be described.

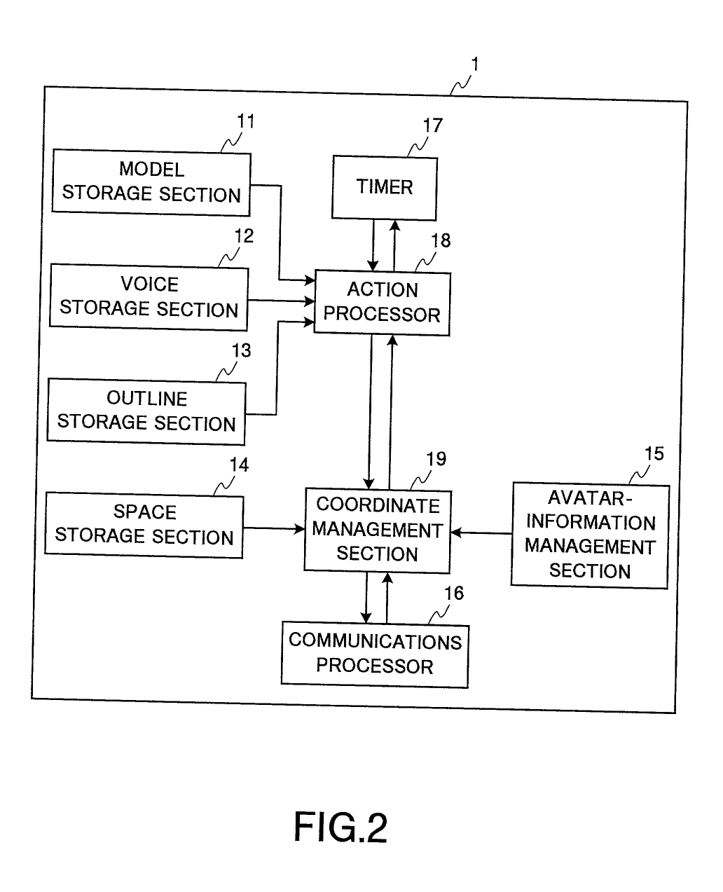

The advertisement server 1 comprises, as shown in FIG. 2, a model storage section 11, a voice storage section 12, an outline storage section 13, a space storage section 14, an avatar information management section 15, a communications processor 16, a timer 17, an action processor 18, and a coordinate management section 19.

The model storage section 11 stores three-dimensional model (3D model) data (model data), representing those items advertised with the three-dimensional advertisements.

The voice storage section 12 stores voice data, such as back music of the three-dimensional advertisement or a catchphrase of the advertisement.

The outline storage section 13 stores various outline data representing a position (coordinates) of the three-dimensional advertisement appearing in the three-dimensional virtual space, types of a 3D model and voice data, movement of the 3D model, and a timing for reproducing voice data. Note that the various outline data are identified by their IDs affixed thereto respectively.

The space storage section 14 stores various data representing a three-dimensional virtual space showing the 3D ad. For example, in the case where to provide a shopping-mall service, the space storage section 14 stores data which is expressed in 3D. Note that various data of the three-dimensional virtual space are identified by their IDs affixed thereto respectively.

The avatar-information management section 15 stores address data of the advertisement client 2 and attribute data of the avatar moving under the control of the user, in association with each other. The attribute data of the avatar includes a type of the avatar, a facing direction of the avatar, and its position (coordinates) in the virtual space, etc. The avatar information management section 15 stores data representing a plurality of avatars. The user actually selects a desired avatar from the plurality of avatars.

The communications processor 16 performs data communications with the advertisement client 2 through the Internet.

The timer 17 times a predetermined period of time. Every time the predetermined period elapses, the timer 17 outputs a start-signal for instructing the action processor 18 to start showing a 3D advertisement, and an outline ID of the 3D ad to be shown, to the action processor 18. Note that the timer 17 decides an outline ID to be output, i.e. a 3D ad to be shown to the user, in accordance with a preset rule.

The action processor 18 sends the start signal and outline ID which are sent from the timer 17, to the advertisement client 2 through the communications processor 16. The action processor 18 reproduces the 3D advertisement, using outline data, model data and voice data.

The coordinate management section 19 manages coordinates of the three-dimensional virtual space for showing the 3D ad, coordinates of the avatar to be moving under the control of the user of the advertisement client 2, and coordinates of the 3D ad.

The structure of the advertisement client 2 will now be explained in more detail.

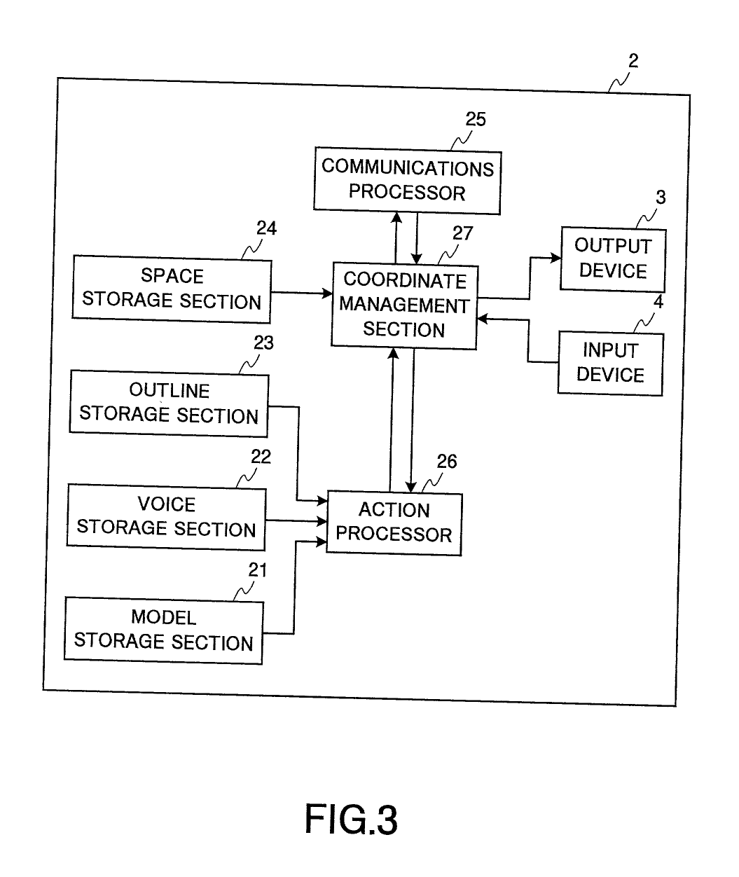

The advertisement client 2 comprises, as shown in FIG. 3, a model storage section 21, a voice storage section 22, an outline storage section 23, a space storage section 24, a communications processor 25, an action processor 26, and a coordinate management section 27.

The model storage section 21 stores substantially the same data as the model data which the model storage section 11 of the advertisement server 1 stores.

The voice storage section 22 stores substantially the same data as the voice data which the voice storage section 12 of the advertisement server 1 stores.

The outline storage section 23 stores substantially the same data as the outline data which the outline storage section 13 of the advertisement server 1 stores.

The space storage section 24 stores substantially the same data as the data representing the three-dimensional virtual space which data is stored in the space storage section 14 of the advertisement server 1.

The communications processor 25 performs data communications with the advertisement server 1 through the Internet.

The action processor 26 obtains model data from the mode storage section 21, voice data from the voice storage section 22, outline data from the outline storage section 23, in accordance with a start signal and outline ID which are sent from the advertisement server 1. The action processor 26 reproduces a 3D advertisement, using the obtained outline data, model data and voice data.

The coordinate management section 27 manages coordinates of the three-dimensional virtual space for showing a 3D ad, coordinates of the avatar to be moving under the control of the user of the advertisement client 2, and coordinates of the 3D ad.

Operations of the advertisement system having the above-described structure will now be described.

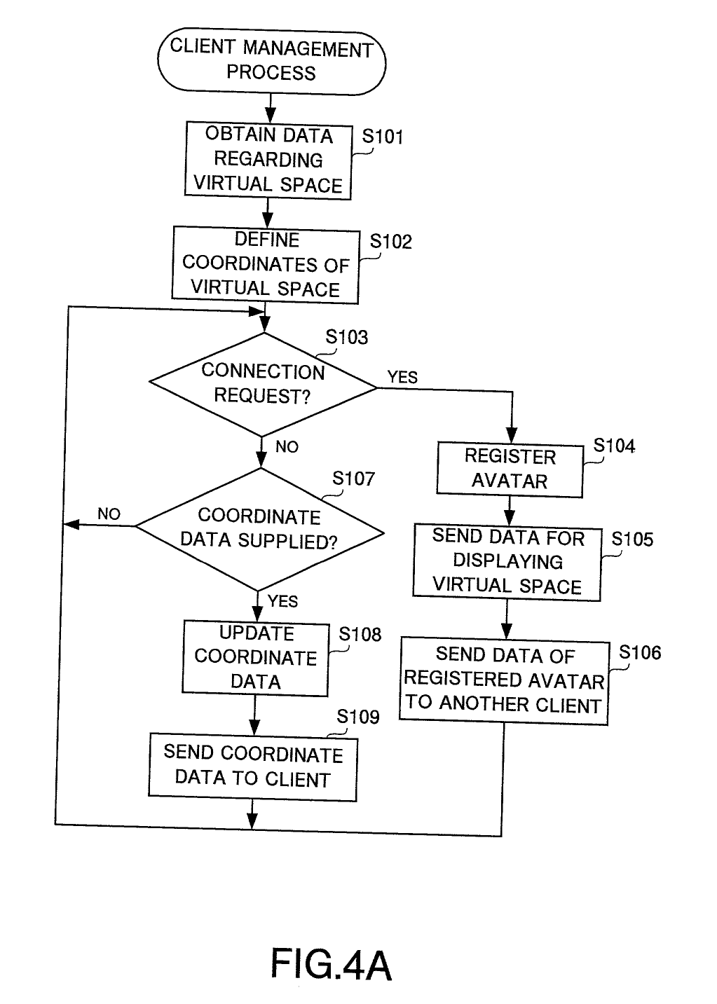

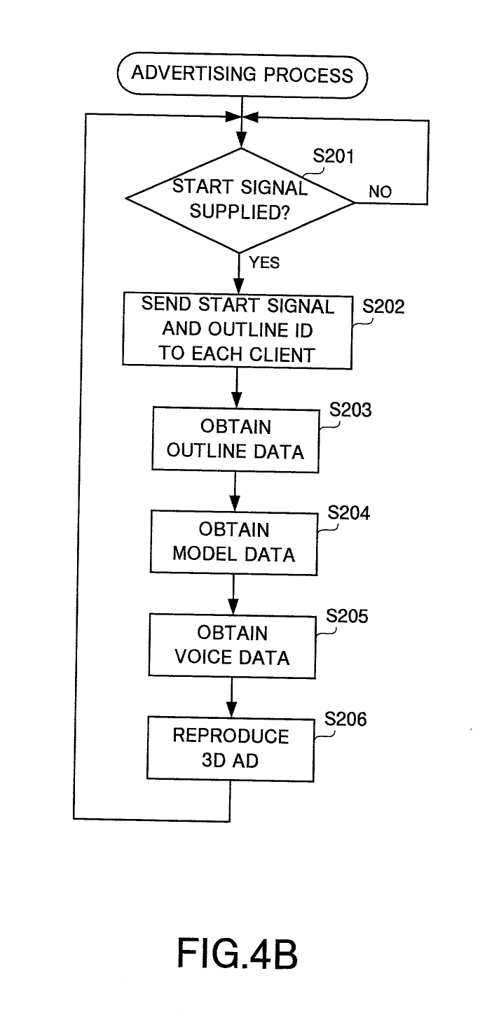

If the advertisement server 1 is activated with a predetermined operation of an operator of the advertisement server 1, the advertisement server 1 separately executes a client management process which is shown in FIG. 4A and an advertising process which is shown in FIG. 4B.

Explanations will now be made to the client management process which is carried out by the coordinate management section 19 of the advertisement server 1.

The coordinate management section 19 obtains predetermined data representing a three-dimensional virtual space, from the space storage section 14 (Step 101).

The coordinate management section 19 defines coordinates for plotting the entire view of the three-dimensional virtual space, using the obtained data (Step S102).

After this, the coordinate management section 19 determines whether a connection request is issued in the advertisement client 2 (Step S103).

In a case where it is determined that the connection request is issued in the advertisement client 2 (Step S103; YES), the coordinate management section 19 registers an avatar which moves in accordance with the operation of the user of the advertisement client 2 having accessed the advertisement server 1 (Step S104). Selection of the avatar is done, for example, in a “log-in” page which is displayed on the display of the output device 3 connected to the advertisement client 2. The coordinate management section 19 stores attributes (including the type, direction, coordinates, etc.) of the user-selected avatar in the avatar information management section 15, in association with an address (an IP address) of the advertisement client 2 having accessed the advertisement server 1. Note that, at this point, the position (coordinates) of the avatar is set into a predetermined initial position. Having performed the above, the coordinate management section 19 registers the user-selected avatar.

The coordinate management section 19 sends data necessary for displaying the three-dimensional virtual space, to the advertisement client 2 having accessed the advertisement server (Step S105). Specifically, the coordinate management section 19 sends a space ID for identifying data representing the three-dimensional virtual space which has been obtained in the step S1O1, data representing the registered avatar and its attribute data, and data representing an avatar moving under the control of a user of another advertisement client 2 and its attribute data. Having performed the above, a predetermined range of the three-dimensional virtual space, which is formed based on the position and direction of the user-selected avatar, is displayed on the advertisement client 2 having accessed the advertisement server 1.

Subsequently, the coordinate management section 19 sends data representing the newly-registered avatar and its attribute data to the another client 2 having already been connected to the advertisement server 1 (Step S106), and the flow returns to the above-described step S103. Then, the newly-registered avatar is displayed on the another advertisement client 2 having already been connected to the advertisement server 1.

In the case where it is determined that no connection request is issued in the advertisement client 2 (Step S103; NO), the coordinate management section 19 determines whether coordinate data representing an avatar is sent from the advertisement client 2 having already been connected to the advertisement server 1 (Step S107). As will specifically be explained later, in the case where the user moves his/her avatar, the advertisement client 2 sends coordinate data of the avatar to the advertisement server 1.

In the case where it is determined that the coordinate data has not been sent therefrom (Step S107; NO), the flow returns to the step S103.

On the contrary, in the case where it is determined that the coordinate data has been sent from the advertisement client 2 (Step S107; YES), the coordinate management section 19 updates the coordinate data which is stored in the avatar information management section 15, based on the sent coordinate data (Step S108).

The coordinate management section 19 sends the updated coordinate data to any one of the advertisement clients 2 having been connected to the advertisement server 1 (Step S109), and the flow returns to the step S103.

In the above manner, the coordinate management section 19 manages the avatar to be moving under the control of each user of the advertisement client 2 connected to the advertisement server 1. The information regarding the avatar is shared between each of the advertisement clients 2 which are connected to the advertisement server 1, through the advertisement server 1. The coordinate management section 19 carries out the above client management process, until the advertisement server 1 stops operating.

Explanations will now be made to the advertising process which is carried out by the action processor 18 included in the advertisement server 1.

The timer 17 of the advertisement server 1 measures a predetermined set period, upon activation of the advertisement server 1. Every time the predetermined period elapses, the timer 17 outputs a start signal for instructing the action processor 18 to start showing a 3D ad and an outline ID for identifying the 3D ad, to the action processor 18.

Upon activation of the advertisement server 1, the action processor 18 determines whether the start signal has been sent from the timer 17 (Step S201).

In the case where it is determined that the start signal has not been sent therefrom (Step S201; NO), the flow returns to the procedure of the step S201.

On the contrary, in the case where it is determined that the start signal has been sent (Step S201; YES), the action processor 18 sends the start signal and outline ID sent from the timer 17 to each advertisement client 2 through the communications processor 16 (Step S202). In this way, the action processor 18 instructs each advertisement client 2 to start showing the 3D ad.

After this, the action processor 18 obtains outline data identified by the outline ID sent from the timer 17, from the outline storage section 13 (Step S203).

The action processor 18 obtains data representing a 3D model indicated by the obtained outline data from the model storage section 11 (Step S204).

Subsequently, the action processor 18 obtains voice data indicated by the obtained outline data from the voice storage section 12 (Step S205).

The action processor 18 reproduces the model data and voice data, in accordance with the obtained outline data. In this way, the action processor 18 reproduces the 3D ad (Step S206), and the flow returns to the procedure of the step S201.

As described above, every time the predetermined period of time elapses, the advertisement client 2 connected to the advertisement server 1 is instructed to show the 3D ad. The action processor 18 carries out the above advertising process, until the advertisement server 1 stops operating upon a predetermined operation of the operator, etc.

Operations performed by the advertisement client 2 will now be explained.

The advertisement client 2 accesses the advertisement server 1 through the Internet, in accordance with the operation of the user.

As explained above, if the coordinate management section 19 of the advertisement server 1 receives a connection request from the advertisement client 2, it sends a space ID, data representing an avatar, and attribute data of the avatar to the advertisement client 2.

The coordinate management section 27 of the advertisement client 2 obtains data representing a three-dimensional virtual space identified by the space ID sent from the advertisement server 1, from the space storage section 24.

The coordinate management section 27 defines coordinates for plotting the entire view of the three-dimensional virtual space, using the obtained data.

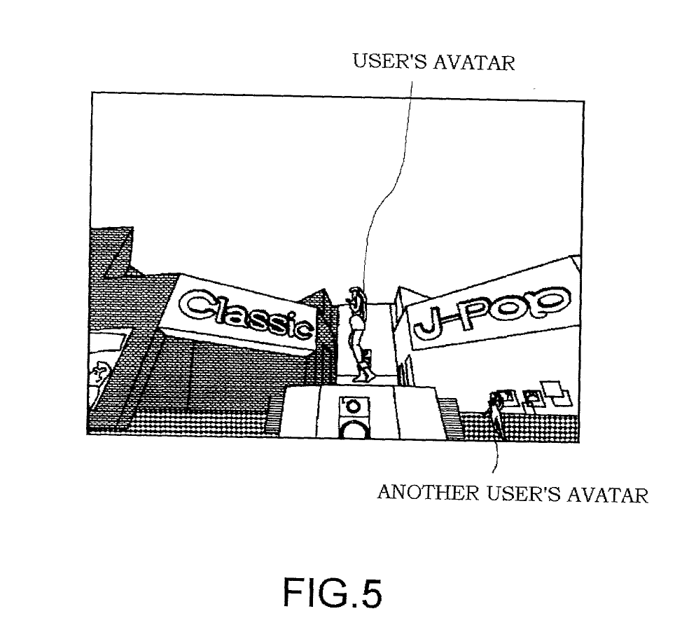

Subsequently, the coordinate management section 27 creates data necessary for displaying the three-dimensional virtual space showing the avatar, based on the obtained data representing the three-dimensional virtual space and the supplied data representing the avatar and its attribute data. After this, the coordinate management section 27 outputs the created data onto the output device 3. In this manner, the three-dimensional virtual space, showing the avatar moving under the control of the user of each advertisement client 2 connected to the advertisement server 1, is displayed on the display of the output device 3, as illustrated in FIG. 5.

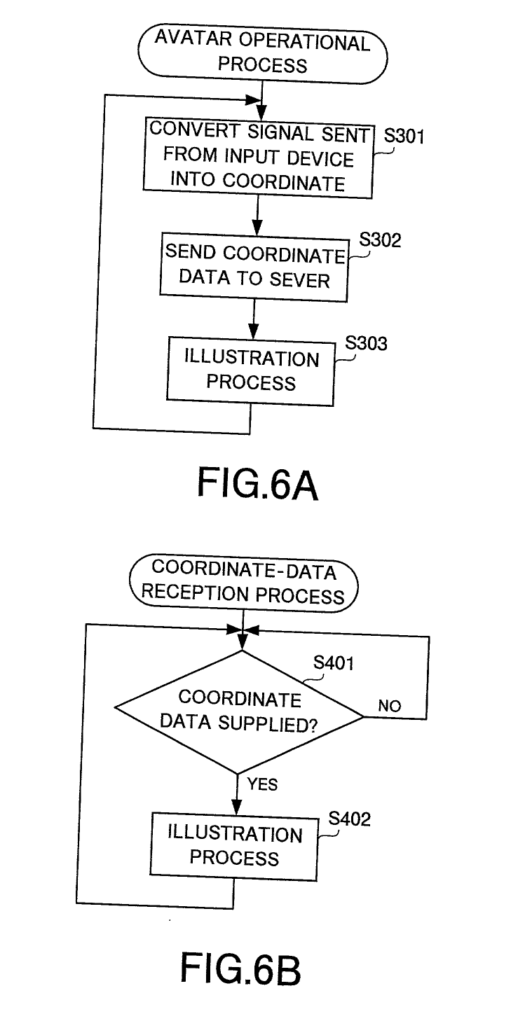

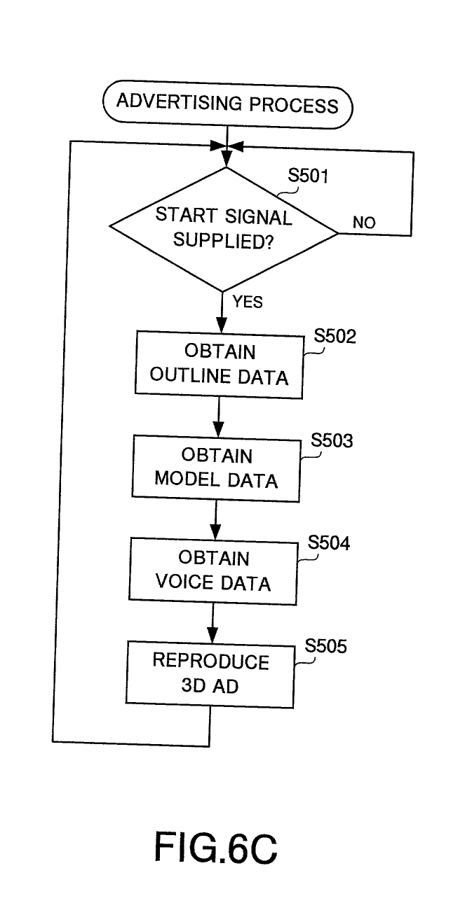

After this, the advertisement client 2 separately executes an avatar operational process shown in FIG. 6A, a coordinate-data reception process shown in FIG. 6B, and an advertising process shown in FIG. 6C.

Explanations will now be made to the avatar operational process which is carried out by the coordinate management section 27 included in the advertisement client 2.

The user of the advertisement client 2 operates the input device 4, to move his/her avatar. The input device 4 outputs a signal corresponding to the operation of the user to the coordinate management section 27 included in the advertisement client 2.

The coordinate management section 27 converts the signal sent from the input device 4 into coordinates of the avatar (Step S301).

The coordinate management section 27 sends the coordinate data of the avatar to the advertisement server 1 through the communications processor 25 (Step S302).

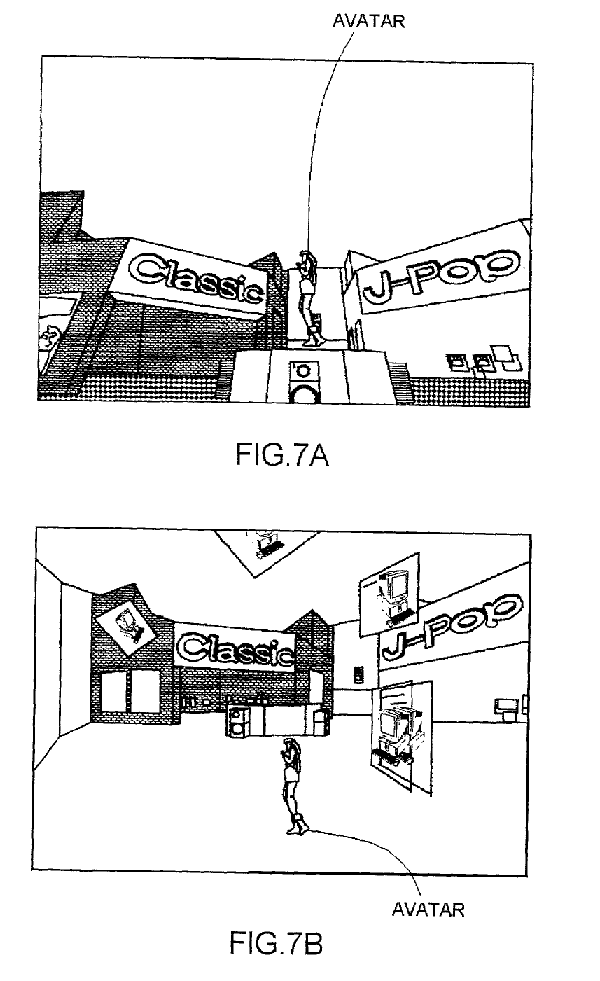

The coordinate management section 27 executes an illustration process (Step S303). Specifically, the coordinate management section 27 newly creates data necessary for showing the moved avatar to be displayed, based on the coordinate and direction of the avatar after being moved, and outputs the created data onto the output device 3. Upon this, as illustrated in FIGS. 7A and 7B, the three-dimensional virtual space showing a different view from that displayed before the avatar has been moved is displayed on the display of the output device 3, and the flow returns to the procedure of the step S301.

Accordingly, the coordinates of the avatar which moves with the operation of the user is occasionally sent to the advertisement server 1. By the above avatar operational process, since the display range of the three-dimensional virtual space changes in accordance with the movement of the avatar, the user can travel within the three-dimensional virtual space by controlling the avatar.

The coordinate data reception process which is carried out by the coordinate management section 27 of the advertisement client 2 will now be described.

As explained above, the coordinate management section 27 of the advertisement client 2 sends the coordinate data representing the position of the moved avatar to the advertisement server 1, when the coordinates change. The coordinate management section 19 of the advertisement server 1 sends the coordinate data sent from each of the advertisement clients 2 to any one of the advertisement clients 2 connected to the advertisement server 1.

The coordinate management section 27 included in the advertisement client 2 determines whether coordinate data representing the position of the avatar moving under the control of the another advertisement client 2 has been sent from the advertisement server 1 (Step S401).

In the case where it is determined that the coordinate data has not been sent (Step S401; NO), the flow returns to the procedure of the step S401.

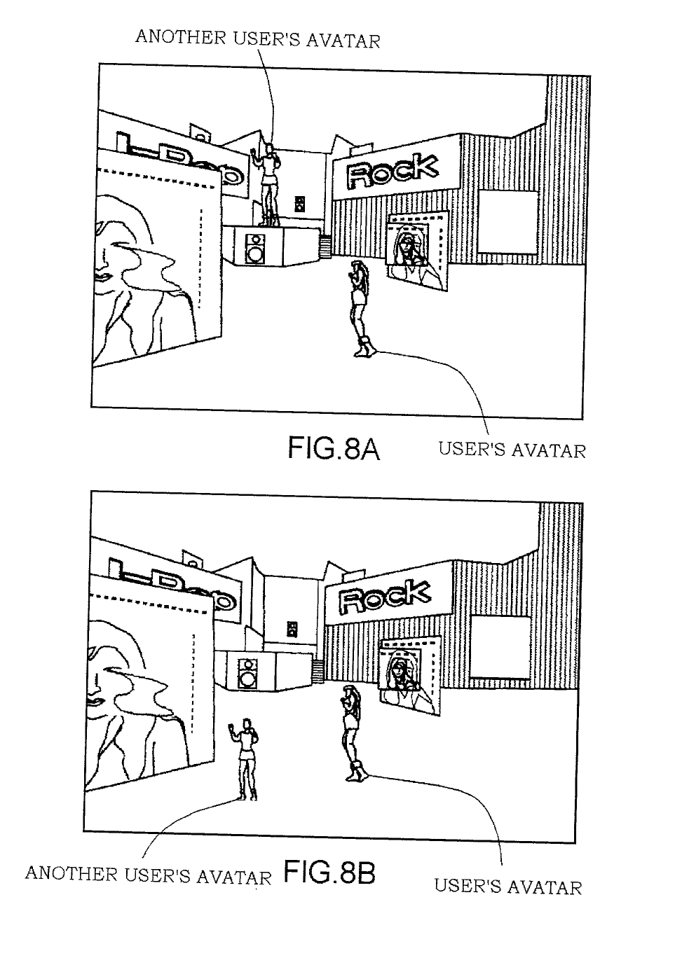

On the contrary, in the case where it is determined that the coordinate data has been sent (Step S401; YES), the coordinate management section 27 executes the illustration process (Step S402). Specifically, the coordinate management section 27 newly creates data necessary for showing the avatar moved under the control of the another advertisement client 2, using the coordinate data sent from the advertisement server 1, and outputs the created data to the output device 3. Then, the avatar, which moves under the control of the user of the another advertisement client 2 and is displayed on the display of the output device 3, moves as illustrated in FIGS. 8A and 8B, and then the flow returns to the step S401.

As explained above, the avatar of another user moves within the three-dimensional virtual space.

The advertising process which is carried out by the action processor 26 included in the advertisement client 2 will now be described.

The action processor 18 of the advertisement server 1 sends the start signal and outline ID, which are sent from the timer 17 at each predetermined period, to each advertisement client 2, as explained above.

The action processor 26 included in the advertisement client 2 determines whether the start signal has been sent from the advertisement server 1 (Step S501).

In the case where it is determined that the start signal has not been sent (Step S501; NO), the flow returns to the procedure of the step S501.

On the contrary, in the case where it is determined that the start signal has been sent (Step S501; YES), the action processor 26 obtains outline data identified by the outline ID sent together with the start signal, from the outline storage section 23 (Step S502).

After this, the action processor 26 obtains data representing a 3D model indicated by the obtained outline data, from the model storage section 21 (Step S503).

Subsequently, the action processor 26 obtains voice data indicated by the obtained outline data, from the voice storage section 22 (Step S504).

The action processor 26 reproduces the model data and voice data, in accordance with the obtained outline data. That is, the action processor 26 reproduces the 3D ad (Step S505), and the flow returns to the procedure of the step S501, wherein the action processor 26 waits for another start signal.

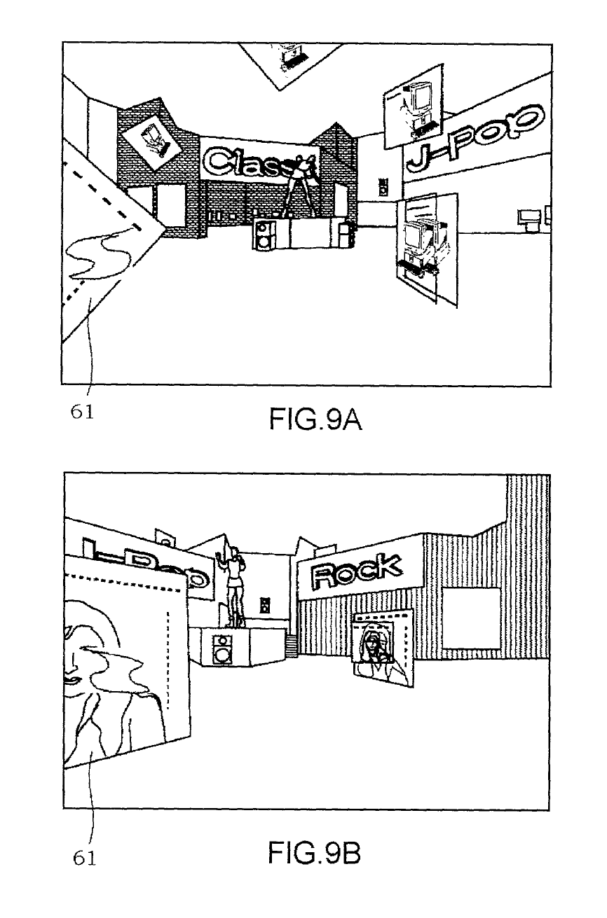

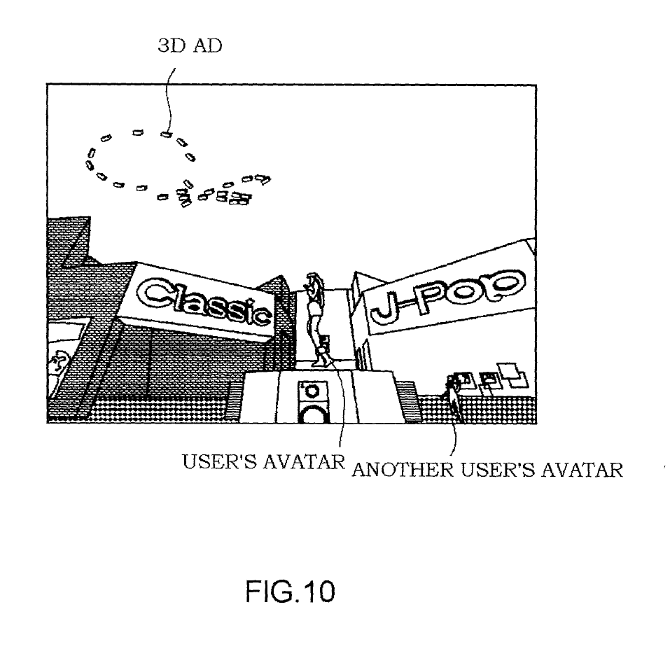

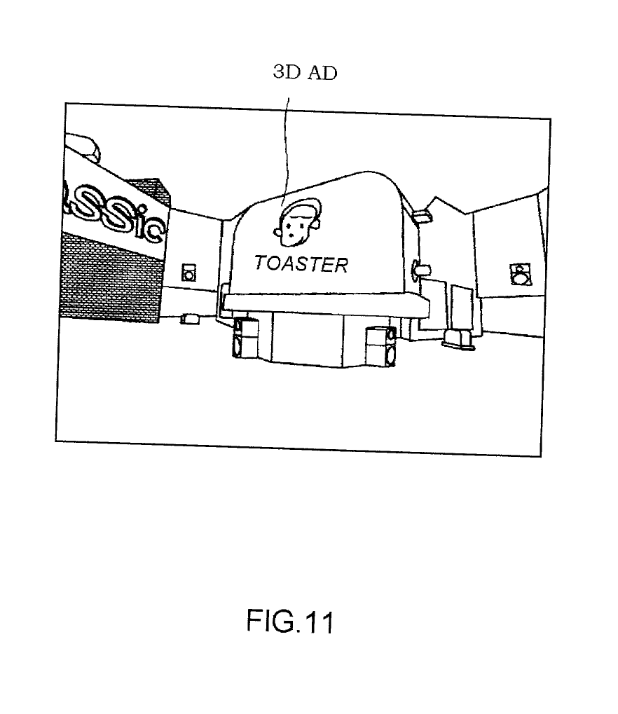

The coordinate management section 27 obtains a position (coordinates) of the 3D advertisement indicated by the outline data, from the action processor 26. The coordinate management section 27 creates data for showing the 3D ad in the obtained position, using the obtained coordinates and the 3D ad to be reproduced by the action processor 26, and outputs the created data onto the output device 3. This achieves in displaying the 3D ad, like that shown in each of FIGS. 9A, 9B, 10, and 11, in a predetermined position of the three-dimensional virtual space. Note that FIG. 9B shows a 3D ad 61, several seconds after the 3D ad 61 of FIG. 9A has been displayed. As seen from FIGS. 9A and 9B, the 3D ad 61 moves, as time goes by.

Accordingly, an effective 3D ad having the image which moves in the above manner is shown within the three-dimensional virtual space which is displayed on each of the advertisement clients 2, at every predetermined period. Since each of the advertisement clients 2 stores various data, including the space, model, voice and outline, etc., the advertisement server 1 needs not send the entire data necessary for showing the 3D ad to each of the advertisement clients 2. Hence, the communications traffic between the advertisement server 1 and advertisement client 2 would be prevented from being increased.

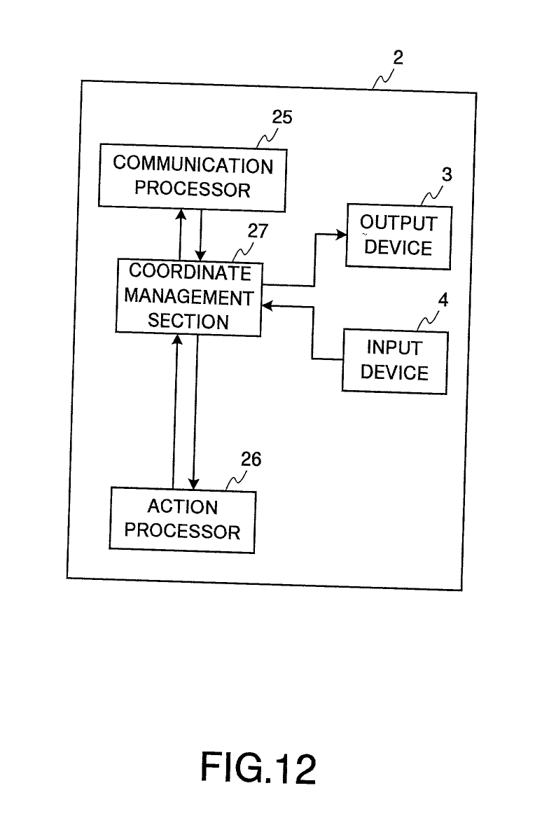

In the above-described embodiment, the explanations have been made to the case where the advertisement client 2 stores the model data, voice data, outline data, and data representing the three-dimensional virtual space, by way of example. As shown in FIG. 12, the advertisement client 2 may not include the model storage section 21, voice storage section 22, outline storage section 23, and space storage section 24. In this case, the action processor 26 and coordinate management section 27 of the advertisement client 2 may search the model storage section 11, voice storage section 12, outline storage section 13, and space storage section 14 included in the advertisement server 1, for necessary data, through the Internet, and obtains the data. Otherwise, a recording medium which records the model data, voice data, outline data, and data representing the three-dimensional virtual space may be set into the advertisement the action processor 26 and coordinate management section 27 may retrieve necessary data from this recording medium. Hence, even in the case where data is frequently updated, it is not necessary to frequently store such data in the advertisement client 2.

In the above-described embodiment, the position (coordinates) where the 3D advertisement is shown has been determined in accordance with the outline data. However, the coordinate management section 27 of the advertisement client 2 may determine the position of the 3D advertisement. For example, the coordinate management section 27 may determine the position where the 3D advertisement can most desirably be shown to the user, based on the coordinates and direction of the avatar moving under the control of the user. The coordinate management section 27 creates data for displaying the 3D advertisement in the determined position, and outputs the created data to the output device 3. This realizes in that the position for displaying the 3D ad can be determined adequately for each of the advertisement clients 2, based on the position and direction of the avatar moving under the control of each user. Thus, the 3D advertisement can effectively be shown to each user.

The system of this embodiment can be realized by a general-purpose computer, without using a dedicated system, etc. For example, a program and data for controlling a computer to execute the above-described processes is stored on a recording medium (such as an FD, CD-ROM, DVD, etc.), and the recording medium may be distributed. The program and data are installed into the computer and run on an OS (Operating System), so as to execute the above processes. The program and data may be stored in a disk device, etc. included in a server device on the Internet, and embedded into a carrier wave so as to be downloaded into a computer.

Various embodiments and changes may be made thereonto without departing from the broad spirit and scope of the invention. The above-described embodiments is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2000-214626 filed on Jul. 14, 2000, and including specification, claims, drawings and summary. The disclosure of the above Japanese Patent Application is incorporated herein by reference in its entirety.

What is claimed is:

1. A three-dimensional advertisement system, comprising:
a server which sends an instruction to at least one client connected to said server through a network to show an advertisement; and
said at least one client which displays a three-dimensional virtual space, and shows a three-dimensional advertisement to be moving, in a predetermined position within the three-dimensional virtual space, in accordance with the instruction which is sent from said server through a network.

2. The three-dimensional advertisement system according to claim 1, wherein said at least one client includes:
a display which displays the three-dimensional virtual space showing an avatar which is a graphical representation of a user in a virtual space; and
a controller which determines a position where the advertisement is shown in the three-dimensional virtual space, in accordance with a position and/or direction of the avatar, and controls said display to show the advertisement in the determined position.

3. The three-dimensional advertisement system according to claim 1, wherein said at least one client includes:
a memory which stores data regarding the advertisement;
a display which displays the three-dimensional virtual space; and
a controller which controls said display to display the advertisement in a predetermined position within the three-dimensional space using the data stored in said memory.

4. The three-dimensional advertisement system according to claim 3, wherein:
said memory stores, as the data regarding the advertisement, model data of a target item to be advertised and outline data indicating a type of the item to be advertised and movement of an image of the item; and
said controller controls said display to show a three-dimensional advertisement to be moving, using the model data and outline data.

5. The three-dimensional advertisement system according to claim 4, wherein said memory further stores, as the data regarding the advertisement, voice data representing back music and/or catch phrase of the advertisement.

6. The three-dimensional advertisement system according to claim 4, wherein:
said memory stores a plurality of pieces of outline data which are identified by outline IDs, respectively;
said server sends a predetermined outline ID to said at least one client; and
said controller controls said display to display a predetermined advertisement, in accordance with one piece of the plurality of pieces of the outline data which is identified by the outline ID sent from said server.

7. The three-dimensional advertisement system according to claim 6, wherein said server includes:
a timer which measures a predetermined period of time; and
a transmission unit which sends a predetermined outline ID to said at least one client, every time the predetermined period of time measured by said timer elapses.

8. A three-dimensional advertising server, comprising:
a timer which measures a predetermined period of time; and
a transmission unit which transmits a signal for instructing at least one client to show a three-dimensional advertisement to be moving to said at least one client, every time the predetermined period of time measured by said timer elapses, and said at least one client being connected to said three-dimensional advertising server through a network, displaying a three-dimensional virtual space, and showing the three-dimensional advertisement in a predetermined position within the three-dimensional virtual space.

9. A three-dimensional advertisement display device, comprising:
a memory which stores data regarding a three-dimensional advertisement to be moving;
a display which displays a three-dimensional virtual space; and
a controller which controls said display to display a three-dimensional advertisement to be moving using the data stored in said memory, in a predetermined position within the three-dimensional virtual space, in response to an instruction sent from a server connected to said three-dimensional advertisement display device.

10. The three-dimensional advertisement display device according to claim 9, wherein:
said display displays a three-dimensional virtual space showing an avatar which is a graphical representation of a user in a virtual space; and
said controller determines a position where the ad is shown within the three-dimensional virtual space, in accordance with a position and/or direction of the avatar, and controls said display to display the ad in the determined position.

11. The three-dimensional advertisement display device according to claim 9, wherein:
said memory stores, as the data regarding the ad, model data of a target item to be advertised and outline data indicating a type of the item to be advertised and movement of an image of the ad; and
said controller controls said display to display a three-dimensional advertisement to be moving using the model data and outline data.

12. The three-dimensional advertisement display device according to claim 11, wherein said memory further stores, as the data regarding the ad, voice data representing back music and/or a catchphrase of the ad.

13. A method for displaying a three-dimensional advertisement, comprising:
sending an instruction from a server to at least one client, connected to said server through a network and displaying a three-dimensional virtual space, to show an ad; and
displaying, on said at least one client, a three-dimensional advertisement to be moving, in a predetermined position within the three-dimensional virtual space, in accordance with the instruction of said server.

14. The method according to claim 13, wherein said displaying the three-dimensional advertisement includes:
displaying, on said at least one client, a three-dimensional virtual space showing an avatar which is a graphical representation of a user in a virtual space;
determining, in said at least one client, a position where to show the three-dimensional advertisement in the three-dimensional virtual space, in accordance with a position and/or direction of the avatar; and
displaying, on said at least one client, the three-dimensional advertisement in the determined position.

15. The method according to claim 13, wherein said displaying the three-dimensional advertisement includes displaying, on said at least one client, the three-dimensional advertisement in a predetermined position within the three-dimensional virtual space, using data regarding the three-dimensional advertisement and being supplied in advance.

16. The method according to claim 15, wherein said sending an instruction includes:
measuring, in said server, a predetermined period of time; and
sending, from said server, a signal for instructing said at least one client to show the three-dimensional advertisement, every time said predetermined period of time elapses.

17. A program for controlling a computer to function as a three-dimensional advertisement display device comprising:
a timer which measures a predetermined period of time; and
a transmission unit which transmits a signal for instructing at least one client to show a three-dimensional advertisement to be moving to said at least one client, every time the predetermined period of time measured by said timer elapses, and said at least one client being connected to said computer through a network, displaying a three-dimensional virtual space, and showing the three-dimensional advertisement in a predetermined position within the three-dimensional virtual space.

18. A program for controlling a computer to function as a three-dimensional advertisement display device comprising:
a memory which stores data regarding a three-dimensional advertisement to be moving;
a displaying which displays a three-dimensional virtual space; and
a controller which controls said display to display a three-dimensional advertisement to be moving, in a predetermined position within the three-dimensional virtual space using the data stored in said memory, in response to an instruction sent from a server connected to said computer through a network.
